(19) United States
(12) Patent Application Publication
(10) Pub. No.: US 2002/0024638 A1
(43) Pub. Date: Feb. 28, 2002

(54) Image input/output apparatus and document presentation apparatus

(76) Inventors: Hirofumi Hidari, Mito-shi (JP); Satoru Sanada, Chigasaki-shi (JP); Toshio Suzuki, Yokohama-shi (JP); Keiichi Nitta, Kawasaki-shi (JP); Takashi Tanemura, Zushi city (JP)

Correspondence Address: Oliff & Berridge PLC, P.O. Box 19928, Alexandria, VA, 22320, US

(21) Appl. No.: 09/748,377

(22) Filed: Dec. 27, 2000

(30) Foreign Application Priority Data
Dec. 27, 1999 (JP) 11-370551
Dec. 4, 2000 (JP) 2000-368127

(51) Int. Cl. G03B 21/08

(52) U.S. Cl. 353/63

(57) ABSTRACT

An image input/output apparatus includes an image-capturing device that captures an image of a subject placed on a stage and a projection-type display device that generates an image based upon an input image signal and projects the image onto a screen. If the image-capturing device is detected to be in the operating state, an illuminating lamp and a projection lamp are turned on and one of the input terminals is selected at a selection means switch. Thus, the image signal from the image-capturing device is selected and an image based upon the image signal is projected from the projection-type display device.

### INCORPORATION BY REFERENCE

The disclosures of the following priority applications are herein incorporated by reference: Japanese Patent Application No. 11-370551 filed Dec. 27, 1999 Japanese Patent Application No. 2000-368127 filed Dec. 4, 2000

### BACKGROUND OF THE INVENTION

1. Field of the Invention

The present invention relates to an image input/output apparatus that converts a captured image of a subject to an image signal and projects an image based upon the image signal onto a screen, and a document presentation apparatus that captures an image of the subject and outputs an image signal.

2. Description of the Related Art

There are liquid crystal projectors that are provided with cameras, which capture an image of a subject placed on a stage with an image-capturing element such as a CCD, convert the captured image to an image signal, generate an image from the image signal on liquid crystal panels and project the image onto a screen by illuminating the liquid crystal panels with a projection illuminating device in the known art. Such a liquid crystal projector is also provided with an illuminating lamp that illuminates the subject placed on the stage. In addition, the liquid crystal projector may be switched to project an image based upon an image signal obtained by capturing an image of the subject with the image-capturing element or to project an image based upon an image signal input from the outside.

The liquid crystal projector in the prior art described above necessitates an operation of numerous switches as detailed below after placing the subject on the stage to project an image onto the screen. Namely, a selector switch for indicating whether an image based upon an image signal resulting from an image-capturing operation or an image based upon an image signal input from the upside is to be projected, a subject illumination switch for turning ON/OFF the subject illuminating lamp, a projection illumination switch for turning ON/OFF the projection illuminating device and the like need to be operated When there are a great number of switches to be operated, the operation is bound to become complicated and thus, the ease of operation is compromised.

### SUMMARY OF THE INVENTION

An object of the present invention is to provide an image input/output apparatus and a document presentation apparatus that require less switch operation and achieve a greater degree of ease of use by engaging various devices in specific operations in correspondence to the operating/non-operating state of an image-capturing device.

The basic components of the image input/output apparatus according to the present invention include an image-capturing device that assumes the operating state or a non-operating state and captures an image of a subject placed on a stage, an image generating means for generating an image based upon an input image signal and a projection illuminating device that illuminates and projects the image generated by the image generating means.

In order to achieve the object described above, the image input/output apparatus according to the present invention further comprises a detection means for detecting whether or not the image-capturing device is in the operating state, a selection means for selecting and outputting either a first image signal output by the image-capturing device or a second image signal input from the outside to the image generating means and a control means for driving the selection means so as to select the first image signal if the detection means detects that the image-capturing device is in the operating state.

Alternatively, the detection means may detect that the image-capturing device is in the non-operating state. In this case, the control means drives the selection means so as to select the second image signal if the image-capturing device is detected to be in the non-operating state. In addition, the image input/output apparatus having the detection means for detecting that the image-capturing device is in the non-operating state may be further provided with a subject illuminating device that illuminates the subject placed on the stage. When this structure is adopted, the control means turns off the subject illuminating device after selecting the second image signal by driving the selection means if the detection means detects that the image-capturing device is in the non-operating state.

The detection means may detect a status shift occurring in the image-capturing device from the non-operating state to the operating state instead.

If the image input/output apparatus is provided with a power switch through which a power ON command is issued, the control means may engage the detection means to detect whether or not the image-capturing device is in the operating state when the power is turned on through the power switch.

The object may be otherwise achieved by turning on the projection illuminating device instead of selecting either the first image signal or the second image signal when the detection means detects that the image-capturing device is in the operating state.

The object described above may also be achieved in the image input/output apparatus according to the present invention having a subject illuminating device by further providing it with a determination means for determining that the subject illuminating device is fully lit and a control means for turning on the subject illuminating device and prohibiting an image signal output until the determination means determines that the subject illuminating device is fully lit if the image-capturing device is detected to be in the operating state.

In addition, the object may be achieved in the image input/output apparatus according to the present invention by providing it with a selection means for selecting and outputting either a first image signal output by the image-capturing device or a second image signal input from the outside to the image generating means, a detection means for detecting whether or not the image-capturing device is in the operating state, a determination means for determining that judges that the subject illuminating device has been completely turned on and a control means for turning on the subject illuminating device and driving the selection means so as to select the first image signal after the determination means determines that the subject illuminating device has been completely turned on if the detection means detects that the image-capturing device is in the operating state, in addition to the basic components described earlier.

Alternatively, the object may be achieved in the image input/output apparatus according to the present invention by providing it with a selection means for selecting and outputting to the image generating means either a first image signal input from the image-capturing device or a second image signal input from the outside, a detection means for detecting the ON/OFF state of the subject illuminating device and a control means for driving the selection means so as to output the first image signal if the detection means detects an ON state and to output the second image signal if the detection means detects an OFF state.

The object may also be achieved in the image input/output apparatus according to the present invention by providing it with a selection means for selecting and outputting to the image generating means either a first image signal input from the image-capturing device or a second image signal input from the outside, a detection means for detecting whether the first image signal or the second image signal has been input and a control means for driving the selection means so as to output the image signal, the input of which has been detected by the detection means. The control means in this image input/output apparatus is capable of prohibiting an image signal output by the selection means if the detection means detects neither the first image signal nor the second image signal.

The structural features described above may be adopted in a document presentation apparatus comprising an image-capturing device that assumes the operating state or the non-operating state and captures an image of a subject placed on a stage, a detection means for detecting whether or not the image-capturing device is in the operating state and a selection means for selecting and outputting either a first image signal output by the image-capturing device or a second image signal input from the outside.

Alternatively, the object described above may be achieved in the document presentation apparatus according to the present invention by providing it with an image-capturing device that assumes the operating state or the non-operating state and outputs an image signal by capturing an image of a subject placed on a stage, a detection means for detecting whether or not the image-capturing device is in the non-operating state and a prohibiting means for prohibiting an image signal output if the detection means detects that the image-capturing device is in the non-operating state.

### BRIEF DESCRIPTION OF THE DRAWINGS

FIG. 1 is an external view of the image input/output apparatus according to an embodiment of the present invention with its image-capturing device being in the operating state;

FIG. 2 is an external view of the image input/output apparatus according to the embodiment of the present invention with its image-capturing device being in the non-operating state;

FIG. 3 is a block diagram schematically illustrating the structure of the image input/output apparatus shown in FIG. 1;

FIG. 4 is a block diagram of the optical system constituting the image generating means;

FIG. 5 presents a flowchart of an example of the processing procedure executed by the CPU;

FIG. 6 presents a flowchart of another example of the processing procedure executed by the CPU;

FIG. 7 is a block diagram schematically illustrating the structure assumed in a first embodiment of the document presentation apparatus adopting the present invention;

FIG. 8 presents a flowchart of an example of the processing procedure executed to determine the operating state/non-operating state of the image-capturing device based upon the ON/OFF state of the illuminating lamp; and

FIG. 9 is a block diagram schematically illustrating the structure assumed in a second embodiment of the document presentation apparatus adopting the present invention.

### DETAILED DESCRIPTION OF THE PREFERRED EMBODIMENTS

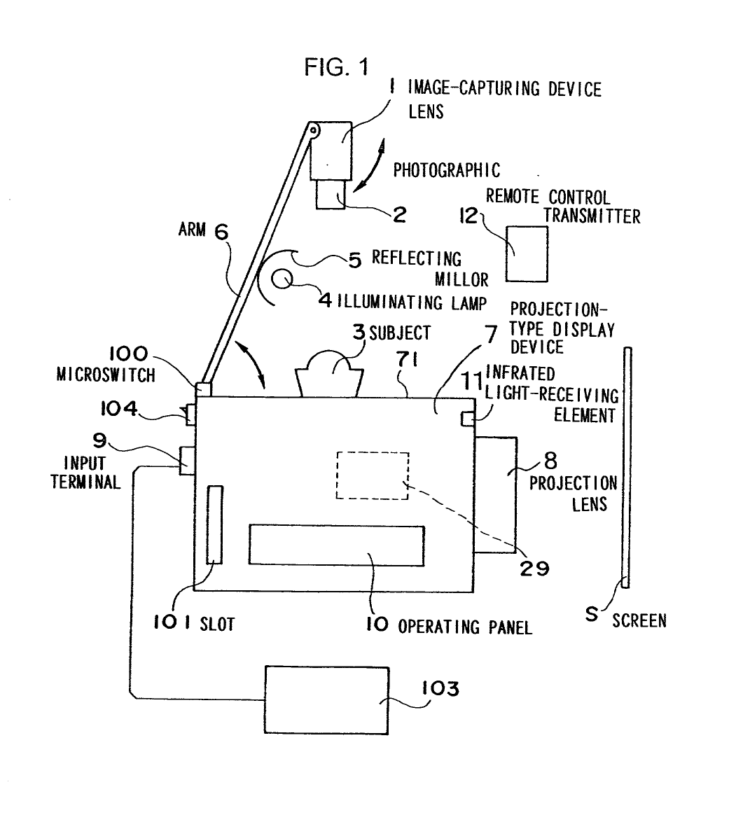

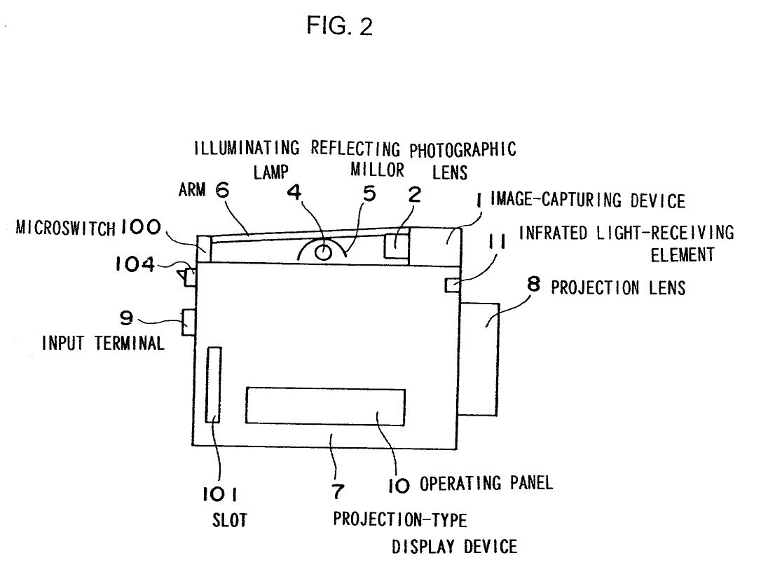

The following is an explanation of the embodiments of the present invention, given in reference to the drawings. FIGS. 1 and 2 each present an external view of the image input/output apparatus according to an embodiment of the present invention. FIG. 1 shows the image input/output apparatus with an image-capturing device 1 being in the operating state, whereas FIG. 2 shows it with the image-capturing device 1 being in the non-operating state. It is to be noted that in the following explanation, the image-capturing device 1 in the operating state, as shown in FIG. 1, corresponds to the non-storage position and the image-capturing device 1 in the non-operating state, as shown in FIG. 2, corresponds to the storage position.

The non-storage position refers to the position at which the image-capturing device 1 can capture an image of a subject 3 placed on a stage 71. The storage position refers to the position at which the image-capturing device 1 is stored at the stage 71 or the position at which it is housed inside a housing member. It is to be noted that the image-capturing device 1 and an illuminating lamp 4 are switched to the operating state or the non-operating state together in the apparatus shown in FIGS. 1 and 2. Alternatively, a structure in which the image-capturing device 1 alone is switched to the operating state or the non-operating state may be adopted. In addition, the non-storage position may be defined as a position at which the subject 3 on the stage 71 can be illuminated by the illuminating lamp 4. In such a case, the storage position is defined as a position at which the illuminating lamp 4 is stored at the stage 71 or a position at which the illuminating lamp 4 is housed inside a housing member.

The power to the image input/output apparatus is turned on through a main switch 104. This image input/output apparatus is provided with the image-capturing device 1 that inputs an image and a projection-type display device 7 that outputs the image. The image-capturing device 1 is rotatably supported at the distal end of an arm 6 provided at a housing of the projection-type display device 7. With its proximal end supported so as to allow it to rotate relative to the housing of the projection-type display device 7, the arm 6 can be folded along the housing of the projection-type display device 7 as shown in FIG. 2. At the arm 6, the illuminating lamp 4 for illuminating the subject 3 and a reflecting mirror 5 are provided. The subject 3 is placed on the stage 71 at the top of the housing of the projection-type display device 7 and is illuminated by the illuminating lamp 4. The image-capturing device 1 captures an image of the illuminated subject 3 via a photographic lens 2.

The projection-type display device 7 generates an image corresponding to an image signal on the liquid crystal panels of an image generating means (hereafter referred to as the optical system) 29 which is to be a detailed later and projects the image onto a screen S via a projection lens 8 by illuminating the liquid crystal panels. The projection-type display device 7 includes an operating panel 10 provided with switches and the like through which commands for various types of operations are issued, an input terminal 9 through which external image signal is input, a slot 101 at which an external storage medium such as a PC card is inserted and a microswitch 100 that detects that the arm 6 has been folded down. An external device 103 which may be, for instance, a video recorder, is connected at the input terminal 9. The projection-type display device 7 is also provided with an infrared light-receiving element 11 to receive an operating signal transmitted from a remote control transmitter 12.

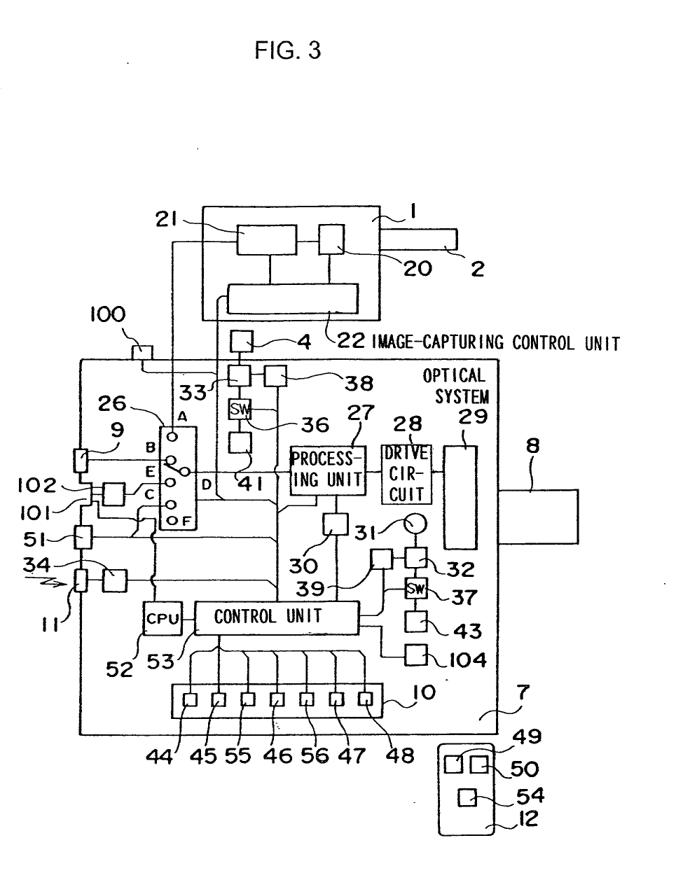

FIG. 3 is a schematic block diagram of the image input/output apparatus according to the embodiment. In FIG. 3, the image-capturing device 1 is provided with the photographic lens 2 that takes in a light flux originating from the subject 3 and an image-capturing element 20 such as a CCD that receives the light flux having entered through the photographic lens 2 , which is then converted to an electrical image signal and output. The image-capturing device 1 is further provided with a signal processing unit 21 and an image-capturing control unit 22. The signal processing unit 21 amplifies an image signal output by the image-capturing element 20 to convert it to a digital signal and implements a specific type of signal processing such as white balance adjustment processing on the digitized signal. The image signal having undergone the signal processing is then transmitted to the projection-type display device 7 from the image-capturing device 1 through a cable housed inside the arm 6 (see FIG. 1). The image-capturing control unit 22 controls the image-capturing element 20 and the signal processing unit 21 in response to a command issued by the projection-type display device 7. The image-capturing control unit 22 also implements control to mute the image signal, as detailed later.

In FIG. 3, the projection-type display device 7 is provided with an image selector switch 26 through which one of a plurality of image signals input through a plurality of input terminals is selected, the optical system 29 that generates an image on the liquid crystal panels based upon the image signal selected at the image selector switch 26, a drive circuit 28 that drives the liquid crystal panels in correspondence to the input image signal and a projection lamp 31 that illuminates the liquid crystal panels on which the image to be projected is generated. The image selector switch 26 outputs an image signal input through one of input terminals A, B, C and E to an output terminal D. An image signal from the signal processing unit 21 of the image-capturing device 1 is input to the input terminal A. An image signal input from the outside is input to the input terminal B. An image signal achieved by decoding with a decode circuit 102 an image signal stored at a PC card installed at the slot 101 is input to the input terminal E. An image signal achieved by decoding an image signal input to a network interface unit 51 via a network is input to the input terminal C. An open terminal F to which no image signal is input is also provided at the selector switch 26. As explained later, when the main switch 104 is turned on for a power-up the selector switch 26 is operated to the open terminal F.

The projection lamp 31 becomes lit as power is supplied to a lighting circuit 32 from a power supply circuit 43 via a switch 37 to illuminate the liquid crystal panels. A counter circuit 39 measures the accumulated length of time over which the projection lamp 31 has been lit. The illuminating lamp 4 becomes lit as power is supplied to a lighting circuit 33 from a power supply circuit 41 via a switch 36 to illuminate the subject 3. A counter circuit 38 measures the accumulated length of time over which the illuminating lamp 4 has been lit. It is to be noted that the projection lamp 31 and the illuminating lamp 4 may each be constituted of a fluorescent lamp or a metal halide lamp.

A certain length of time must elapse before a fluorescent lamp or a metal halide lamp enters a stable state after it is turned on from an unlit state. The length of time it takes a fluorescent lamp to become lit increases in proportion to the length of time having elapsed since it was turned off most recently and in reverse proportion to the level of the ambient temperature. Accordingly, as explained later, an image signal input to the projection-type display device 7 is prohibited over a specific length of time after the illuminating lamp is turned on, and then, after the specific length of time elapses, an image signal input to the projection-type display device 7 is enabled. As a result, a poor image can be prevented from being projected while the illuminating light quantity is increasing. An image signal input may be prohibited by setting the selector switch 26 to the open terminal F and thus blocking any image signal from entering the projection-type display device 7 or by muting the image signal at the image-capturing device 1. A mute circuit may be internally provided at the signal processing unit 21 or it may be internally provided at a processing unit 27. Alternatively, screen data may be output by an OSD memory 30 which is to be detailed later to the processing unit 27 to be superimposed over the entire image signal.

In addition, the projection-type display device 7 is provided with a CPU 52 that controls the various devices and circuits of the image input/output apparatus, a control unit 53 that inputs/outputs control signals for various components of the image-capturing device 1 and the projection-type display device 7 in response to commands issued by the CPU 52, and the processing unit 27 that implements γ control processing on an image signal and outputs the image signal having undergone the γ control processing to the drive circuit 28. The processing unit 27 creates an overlay image by superimposing overlay data read out from the OSD memory 30 on the image having undergone the γ control processing. The OSD memory 30 stores in memory the overlay data to be superimposed on the image in response to a drive signal output by the control unit 53, reads out the stored overlay data and sends them to the processing unit 27. It is to be noted that the overlay data may be, for instance, text data such as an on-screen menu or screen data used to replace the entire image.

As described above, the operating panel 10 is provided at the projection-type display device 7. At the operating panel 10, operating switches 44, 45 and 55 through which the image selector switch 26 is operated, an operating switch 46 which is operated to turn ON/OFF the illuminating lamp 4, an operating switch 56 that is operated to turn on/off the projection lamp 31, an illuminating lamp indicator 47 and a projection lamp indicator 48 are provided. The illuminating lamp indicator 47 indicates information related to the accumulated length of time over which the illuminating lamp 4 has been lit. The projection lamp indicator 48 indicates information related to the accumulated length of time over which the projection lamp 31 has been lit.

The image selector switch 26 is operated to select one of the plurality of image signals input to the projection-type display device 7. The image selector switch 26 is operated through an operation of the switch 44, 45 or 55 provided at the operating panel 10 performed by the user. The switch 44 is operated to switch the input of the image selector switch 26 to the terminal B and the switches 45 and 55 are respectively operated to switch the input of the selector switch 26 to the terminal A and the terminal C. When one of these switches is operated by the user, a switch selection command signal is transmitted to the control unit 53. In response to the received switch selection command signal, the control unit 53 outputs a switch selection command signal for the selector switch 26. The input of the selector switch 26 is operated to the terminal E when the CPU 52 detects that a PC card has been inserted at the slot 101. Namely, the CPU 52 checks the signal level at the pin assigned for connect/disconnect detection at a PC card connector provided inside the slot 101. When the signal level at the connect/disconnect detection pin shifts to indicate a specific value, the CPU 52 decides that a PC card has been installed and outputs a switch selection command signal for the selector switch 26 via the control unit 53.

In the embodiment, if the image-capturing device 1 is in the operating state, the illuminating lamp 4 and the projection lamp 31 are lit when the main switch 104 is turned on for a power-up as explained later. If the image-capturing device 1 is in the non-operating state, the projection lamp 31 is turned on but the illuminating lamp 4 remains unlit. However, the projection lamp 31 may be turned ON/OFF through an operation of the switch 56 provided at the operating panel 10 as well. In response to an ON/OFF command signal input through the switch 56, the control unit 53 outputs a drive signal for turning ON/OFF the projection lamp 31 to the switch 37. When the switch 37 is turned on, power is supplied from the power supply circuit 43 for the projection lamp 31 to the lighting circuit 32 which then turns on the projection lamp 31. If, on the other hand, the switch 37 is turned off, the power supply to the lighting circuit 32 is cut off and the projection lamp 31 is turned off. The counter circuit 39 measures the accumulated length of time over which the projection lamp 31 has been lit and provides the counting results to the control unit 53. The counter circuit 39 suspends the counting operation while the projection lamp 31 is unlit. The counting results obtained at the counter circuit 39 are indicated at the indicator 48. The indicator 48 remains unlit under normal circumstances and flashes if the accumulated length of time over which the projection lamp 31 has been lit exceeds a specific length of time. The indication at the indicator 48 is controlled by the control unit 53. When the accumulated length of time over which the projection lamp 31 has been lit exceeds the specific length of time, warning text data may be output by the OSD memory 30 to the processing unit 27 to display a warning message superimposed on the projected image.

In addition, through an operation at the switch 46 provided at the operating panel 10, the illuminating lamp 4 may be turned ON/OFF. In response to an ON/OFF command signal input through the switch 46, the control unit 53 outputs a drive signal for turning ON/OFF the illuminating lamp 4 to the switch 36. When the switch 36 is turned on, power is supplied from the power supply circuit 41 for the illuminating lamp 4 to the lighting circuit 33 which then lights the illuminating lamp 4. If, on the other hand, the switch 36 is turned off, power supply to the lighting circuit 33 is cut off and the illuminating lamp 4 is turned off. The counter circuit 38 measures the accumulated length of time over which the illuminating lamp 4 has been lit and provides the counting results to the control unit 53. The counter circuit 38 suspends the counting operation while the illuminating lamp 4 is off. The counting results obtained at the counter circuit 38 are indicated at the indicator 47. The indicator 47 remains unlit under normal circumstances and flashes if the accumulated length of time over which the projection lamp 4 has been lit exceeds a specific length of time. The indication at the indicator 47 is controlled by the control unit 53. When the accumulated length of time over which the illuminating lamp 4 has been lit exceeds the specific length of time, warning text data may be output by the OSD memory 30 to the processing unit 27 to display a warning message superimposed on the projected image.

The projection-type display device 7 may be operated in response to an operating signal transmitted from the remote control transmitter 12 instead of the operation at the operating panel 10. The infrared light-receiving element 11 receives an operating signal constituted of infrared light transmitted from the remote control transmitter 12 and converts the received operating signal to an electrical signal. The operating signal constituted of infrared light is transmitted from the remote control transmitter 12 when the user operates the remote control transmitter 12. The operating signal having been converted to an electrical signal at the infrared light-receiving element 11 is then demodulated at a demodulator circuit 34, and becomes decoded at a decode circuit provided within the control unit 53. The operating signal undergoing the decoding process is converted to an operating signal which is used to switch the input of the image selector switch 26. Signals generated by operating switches 49, 50 and 54 provided at the remote control transmitter 12 are respectively converted at the decode circuit to the switch selection command signals for switching the input of the image selector switch 26 to the terminal A, the terminal B and the terminal C. The control unit 53 outputs a switch selection signal for the selector switch 26 in correspondence to the current switch selection command signal.

The projection-type display device 7 is further provided with the microswitch 100 that detects that the arm 6 has been raised into the operating state as shown in FIG. 1, and the detection signal is output to the control unit 53. The microswitch 100 is turned on when the arm 6 is at the non-storage position (the operating state) as illustrated in FIG. 1, whereas the microswitch 100 is turned off when the arm 6 is in the stored state (the non-operating state) as illustrated in FIG. 2, to enable detection of the operating/non-operating state of the image-capturing device 1. It is to be noted that the microswitch 100 shifts from an ON state to an OFF state as the arm 6 shifts from the non-storage position to the storage position. The control unit 53 can thus ascertain a shift from the operating state to the non-operating state based upon a change in the signal from the microswitch 100.

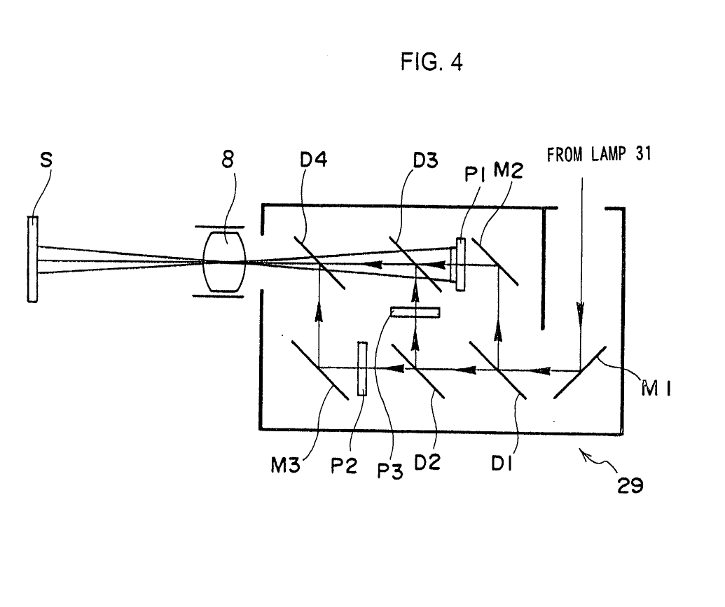

Next, the optical system 29 is explained in detail in reference to FIG. 4. The optical system 29 includes liquid crystal panels P1˜P3 that generate images in R, G and B colors respectively, and RGB separation dichroic mirrors D1 and D2 that illuminate the liquid crystal panels P1˜P3 by separating illuminating light from the projection lamp 31 (see FIG. 3) into R, G and B. The light emitted from the projection lamp 31 (see FIG. 3) is reflected at a mirror Ml and then enters the dichroic mirror D1 which reflects red-color light. The dichroic mirror D1 only reflects red-color light and allows the remaining light to be transmitted. The red-color light having been reflected at the dichroic mirror D1 is reflected again at a mirror M2, is transmitted through the red-color liquid crystal panel P1, and dichroic mirrors D3 and D4 provided for color synthesis, and is output to the projection lens 8.

The light having been transmitted through the dichroic mirror D1 enters the dichroic mirror D2 which reflects blue-color light. The dichroic mirror D2 reflects blue-color light only and allows the remaining light to be transmitted. The blue-color light having been reflected at the dichroic mirror D2 is then transmitted through the blue-color liquid crystal panel P3, is reflected at the dichroic mirror D3 for color synthesis, and is transmitted through the dichroic mirror D4 to be output to the projection lens 8. The green-color light having been transmitted through the dichroic mirror D2 is then transmitted through the green-color liquid crystal panel P2, and is reflected at a mirror M3 and the dichroic mirror D4 for color synthesis to be output to the projection lens 8.

The synthesized light constituted of red-color, blue-color and green-color light output to the projection lens 8 as described above is then projected onto the screen S through the projection lens 8. As described above, the optical system 29 drives the liquid crystal panels P1˜P3 in response to drive signals provided by the drive circuit 28 to allow the images formed on the liquid crystal panels P1˜P3 to undergo spatial modulation with the illuminating light from the projection lamp 31, to be ultimately projected onto the screen S (see FIG. 1) through the projection lens 8.

In the image input/output apparatus structured as described above, ON/OFF control of the illuminating lamp 4 and the projection lamp 31 is implemented by detecting that the image-capturing device 1 is in the operating state (at the non-storage position) or by detecting that the image-capturing device 1 is in the non-operating state (at the storage position).

1. Turning on the illuminating lamp 4 and the projection lamp 31

When the main switch 104 is turned on for a power-up, the selector switch 26 is switched to the open terminal F. In addition, if a status change occurs between the operating state and the non-operating state of the image-capturing device 1 while the main switch 104 is in an ON state, the selector switch 26 is operated to the open terminal F. Since the open terminal F is open, no image signal is selected. When the arm 6 is set in the state shown in FIG. 1 to allow the image-capturing device 1 to enter the operating state, the projection lamp 31 and the illuminating lamp 4 are both turned on. When the lamp light quantities become stabilized with a specific length of time having elapsed after the lamps were turned on, the selector switch 26 is operated to the input terminal A to input an image signal from the image-capturing device 1 to the processing unit 27. As a result, an image based upon the image signal resulting from an image-capturing operation performed at the image-capturing device 1 is generated on the liquid crystal panels, the liquid crystal panels are illuminated with illuminating light from the projection lamp 31, and the image is projected onto the screen by the projection optical system.

2. Turning off the illuminating lamp 4 and the projection lamp 31 and switching the image input

(I) If the image-capturing device 1 is detected to be at the storage position and therefore in the non-operating state, as illustrated in FIG. 2, when the main switch 104 is turned on for a power-up, or the operating status of the image-capturing device 1 has changed between the operating state and the non-operating state, an image signal input from the outside is input to the processing unit 27 by turning on the projection lamp 31 and switching the selector switch 26 to the external input terminal B and the illuminating lamp 4 is turned off. As a result, an image is generated on the liquid crystal panels based upon the image signal input from the outside, and the image is projected onto the screen.

(II) If it is detected that the image-capturing device 1 is not in the operating state (it is not at the non-storage position) while the illuminating lamp 4 and the projection lamp 31 are lit, the selector switch 26 is operated to the input terminal B to select an external signal input and the illuminating lamp 4 of the image-capturing device 1 is turned off. Thus, an image is generated on the liquid crystal panels based upon the image signal input from the outside and the image is projected onto the screen.

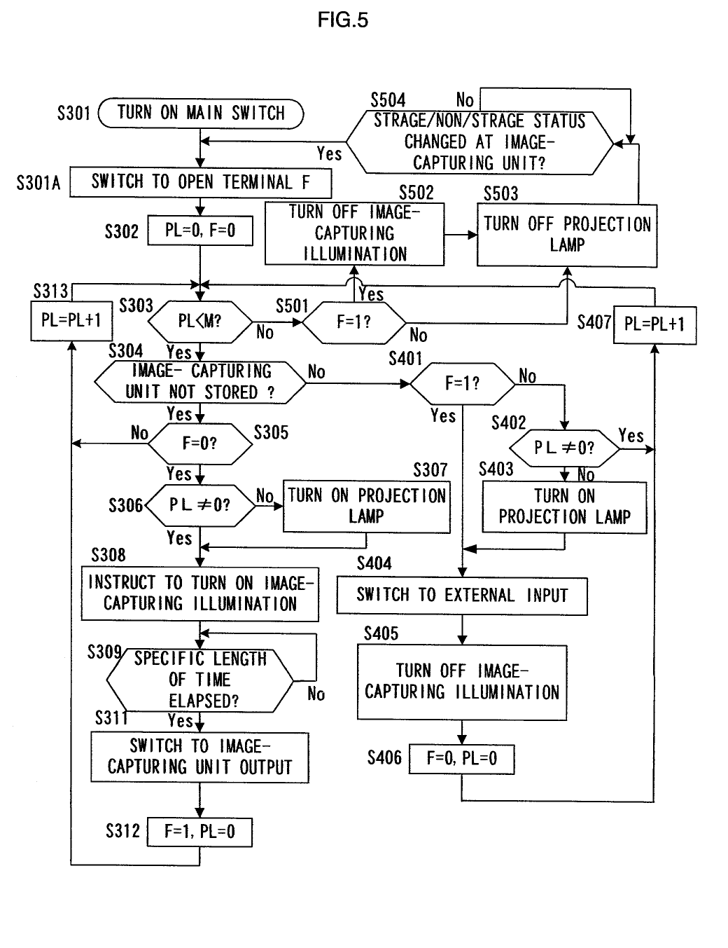

FIG. 5 shows the processing procedure executed by the CPU 52 to control the ON/OFF states of the illuminating lamp 4 and the projection lamp 31 and the image input selection in correspondence to the operating state/non-operating state of the image-capturing device 1. While the processing executed in the individual steps is actually executed by the CPU 52, it is described below as operations of the various devices performed in response to commands from the CPU 52 to facilitate the explanation.

The processing starts in step S301 as the main switch 104 is turned on. In step S301A, all image signal input is prohibited by switching the selector switch 26 to the open terminal F. In step S302, 0 is set for both variables PL and F. The variable PL indicates the number of times over which a plurality of specific steps are looped as detailed later, and is used to make a decision as to whether or not the image-capturing device 1 has sustained the operating state over a specific length of time after the main switch 104 is turned on. The variable F indicates the operating/non-operating state of the image-capturing device 1. F=1 indicates that the image-capturing device 1 is already in the operating state, i.e., that the illuminating lamp 4 is lit. F=0 indicates that the image-capturing device 1 is in the non-operating state, i.e., that the illuminating lamp 4 is turned off.

If it is decided in step S303 that the variable PL is smaller than a specific value M, the operation proceeds to step S304. If it is decided in step S304 that the image-capturing device 1 is at the non-storage position based upon the detection signal from the microswitch 100, the operation proceeds to step S305. If it is decided in step S305 that the variable F is 0, the operation proceeds to step S306. If it is decided in step S306 that the variable PL is 0, i.e., immediately after a power-up, the projection lamp 31 is turned on in step S307 before the operation proceeds to step S308. The operation also proceeds to step S308 if it is decided in step S306 that the variable PL is not 0. In step S308, an instruction to turn on the illuminating lamp 4 to illuminate the subject is issued.

If it is decided in step S309 that a specific length of time has elapsed since the instruction to turn on the illuminating lamp 4 was issued and that the illuminating lamp 4 is fully lit, the operation proceeds to step S311. The specific length of time is set in reference to the length of time required for the quantity of light emitted by the illuminating lamp 4 to become stabilized. In step S311, the selector switch 26 is operated to the input terminal A so as to allow an image signal from the image-capturing device 1 to be input to the processing unit 27. Then, the operation proceeds to step S312 to set 1 for the variable F and set 0 for the variable PL before proceeding to step S313. In step S313, the variable PL is incremented by 1 before the operation returns to step S303. The operation also proceeds to step S313 if it is decided in step S305 that the variable F is not 0.

If it is decided in step S303 that the variable PL is a value equal to or greater than the specific value M, the operation proceeds to step S501. If it is decided in step S501 that the variable F is 1, the illuminating lamp 4 of the image-capturing device 1 is turned off in step S502 before the operation proceeds to step S503. In step S503, the projection lamp 31 is turned off and then the operation proceeds to step S504. If it is decided in step S501 that the variable F is not 1, the operation proceeds to step S503 and then to step S504. If it is decided in step S504 that the image-capturing device 1 has been reset from the non-storage position to the storage position or from the storage position to the non-storage position, the operation returns to step S301A. If, on the other hand, the position of the image-capturing device 1 has not changed, the processing in step S504 is repeatedly executed.

If the image-capturing device 1 is at the storage position, a negative decision is made in step S304 and the operation proceeds to step S401. If it is decided in step S401 that the variable F is not 1, i.e., if it is decided that the illuminating lamp 4 has already been turned off, the operation proceeds to step S402. If it is decided that the variable PL is 0 in step S402, i.e., if the processing in step S302 has been executed shortly before (immediately after the main switch 104 is turned on or immediately after an affirmative decision is made in step S504 as a result of a change in the operating status of the image-capturing device 1), the projection lamp 31 is turned on in step S403 and the operation proceeds to step S404. In step S404, the selector switch 26 is controlled to select the external input. Namely, the selector switch 26 is operated to the input terminal B. Then, the operation proceeds to step S405 to turn off the illuminating lamp 4 of the image-capturing device 1, and the variable F and the variable PL are reset to 0 in step S406 before the operation proceeds to step S407. In step S407, the variable PL is incremented by 1 before the operation returns to step S303. If the image-capturing device 1 is already in the operating state and the illuminating lamp 4 and the projection lamp 31 are both lit, it is decided in step S401 that the variable F is 1, and the operation skips steps S402 and S403 to proceed to steps S404-S406. If it is decided in step S402 that the variable PL is not 0, the variable PL is incremented by 1 in step S407 before the operation returns to step S303.

As explained above, by turning ON/OFF the illuminating lamp 4 and the projection lamp 31 in correspondence to whether the image-capturing device 1 is at the non-storage position (in the operating state) or at the storage position (in the non-operating state), the power consumption can be reduced. In addition, since it is not necessary to perform a special operation to turn ON/OFF the lamps, the operability is improved. Furthermore, since the image signal obtained through an image-capturing operation at the image-capturing device 1 or the image signal input from the outside is selected in correspondence to the operating/non-operating state of the image-capturing device 1, the need to perform a special switching operation is eliminated to improve the operability.

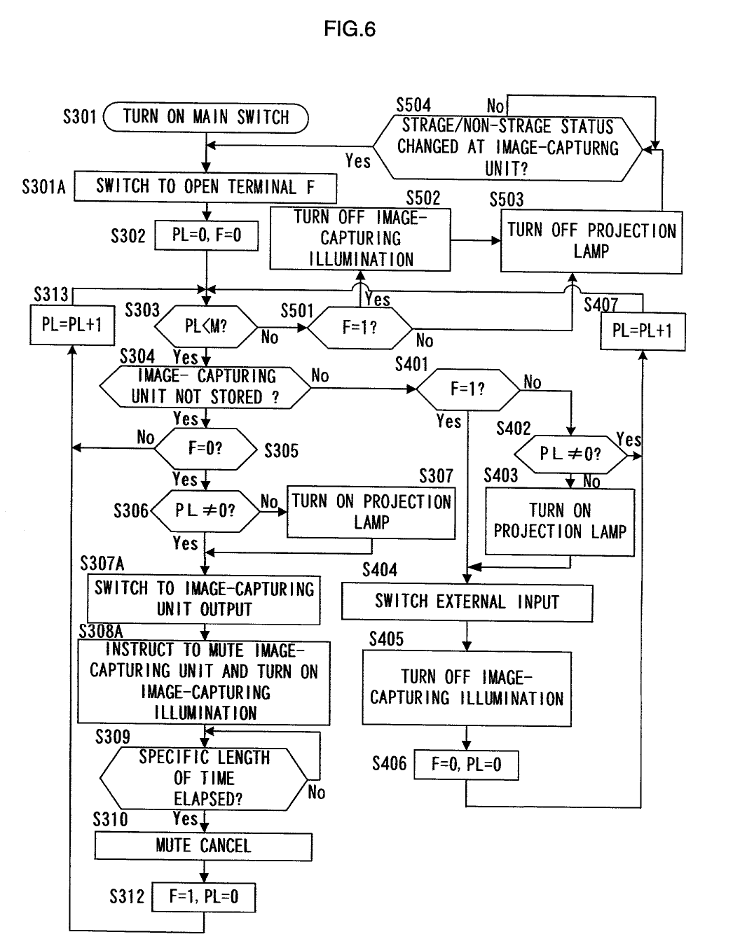

FIG. 6 presents an example of a variation of the processing procedure shown in FIG. 5. The following explanation focuses on the differences from the procedure shown in FIG. 5. In FIG. 5, an input of the image signal from the image-capturing device 1 to the projection-type display device 7 is disallowed until the operation of the illuminating lamp 4 becomes stabilized, to prevent a poor image from being projected onto the screen. In the present example, the image signal is muted. After the projection lamp 31 is turned on in step S307, the selector switch 26 is switched to the input terminal A in step S307A. In step S308A, the image signal is muted at the image-capturing device 1 and an instruction to turn on the illuminating lamp 4 is issued. When a specific length of time has elapsed after the instruction to turn on the illuminating lamp 4 is issued and the quantity of light emitted by the lamp has become stabilized, the image signal mute is canceled. Thus, an image based upon the image signal resulting from the image-capturing operation at the image-capturing device 1 is generated at the liquid crystal panels and is projected onto the screen after the operation of the illuminating lamp 4 becomes stabilized. Alternatively, screen data may be output by the OSD memory 30 to the processing unit 27 to be superimposed on the image signal.

In the examples shown in FIGS. 5 and 6, the image signal input from the outside or the image signal obtained through an image-capturing operation at the image-capturing device 1 can be selected through the image signal selector switch 26. However, the present invention may be adopted in an image input/output apparatus that projects only an image signal obtained at the image-capturing device 1. In such a case, the illuminating lamp 4 can be turned on when the image-capturing device 1 is detected to be in the operating state. In addition, an image signal input to the projection-type display device 7 may be prohibited or the image signal may be muted until the light quantity at the illuminating lamp 4 becomes stabilized. However, an image signal input need not be prohibited or the image signal does not need to be muted.

In the examples shown in FIGS. 5 and 6, an image signal input is prohibited or the image signal is muted over a specific length of time during which the light quantity at the illuminating lamp 4 becomes stabilized. This specific length of time may be the maximum length of time required for the illuminating lamp to become fully lit. Alternatively, the specific length of time may be varied, to be set in correspondence to the ambient temperature measured with a temperature sensor (not shown) or the measured length of time having elapsed since the illuminating lamp was turned off most recently.

It is to be noted that even when the input terminal A is selected through the switch 26 while the image-capturing device 1 is in the operating state (at the non-storage position), the CPU 52 allows an interrupt processing in response to an operation of the switch 44. In this situation, the CPU 52 selects the input terminal B by controlling the switch 26. As a result, an image signal from the external input terminal 9 is transmitted to the processing unit 27.

While an explanation is given above on an image input/output apparatus having the image-capturing device 1 and the projection-type display device 7, the present invention may be adopted in a document presentation apparatus having an image-capturing device 1 that outputs an image signal by capturing an image of the subject 3 and an image selector device that selects the image signal output by the image-capturing device 1 or an image signal input from the outside.

First Embodiment of Document Presentation Apparatus

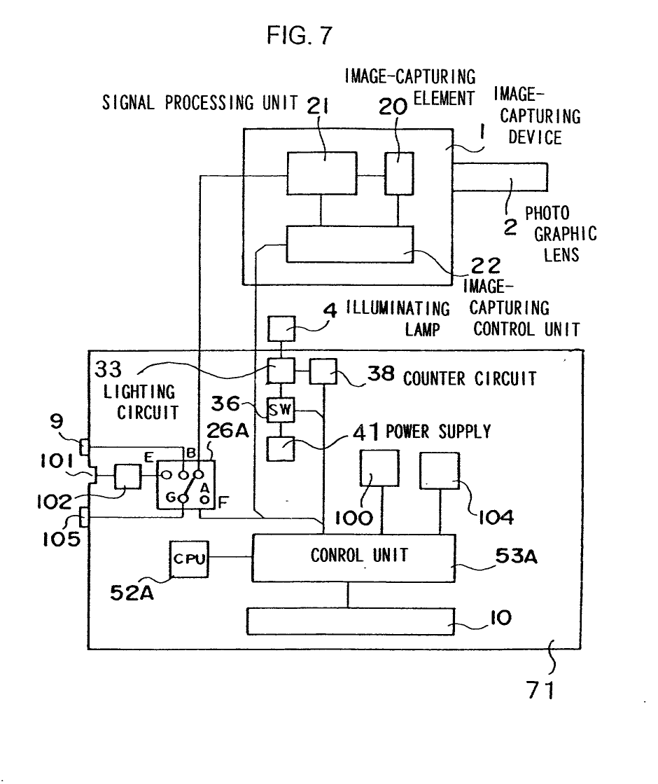

FIG. 7 is a block diagram of the first embodiment of the document presentation apparatus adopting the present invention. In FIG. 7, the same reference numbers are assigned to components identical to those shown in FIG. 3 to preclude the necessity for a repeated explanation. A selector switch 26A includes three input terminals A, B and E, one open terminal F and one output terminal G. An image signal from the image-capturing device 1 is input to the input terminal A, an external image signal input through the external input terminal 9 is input to the input terminal B, and an image signal from a PC card installed at the slot 101 is input to the input terminal E. The open terminal F is an open terminal to which no image signal is input. The output terminal G is connected to an external output terminal 105. The selector switch 26A is switched via a control unit 53A in response to a command issued by a CPU 52A.

In this apparatus, the following operations can be performed when image-capturing device 1 is determined to be in the operating state or the non-operating state.

1. If the image-capturing device is detected to be in the operating state, the illuminating lamp 4 is turned on.

2. If the image-capturing device is detected to be in the operating state, the image signal provided by the image-capturing device 1 is selected.

3. If the image-capturing device is detected to be in the non-operating state, the output of an image signal by the image-capturing device 1 is prohibited.

4. If the image-capturing device is detected to be in the non-operating state, the illuminating lamp 4 is turned off.

5. If the image-capturing device is detected to be in the non-operating state, the output of an image signal by the image-capturing device 1 is prohibited and the illuminating lamp 4 is turned off.

In the document presentation apparatus described above, the image-capturing device 1 is detected to be in the operating state or the non-operating state depending upon whether the arm supporting the image-capturing device 1 is at the non-storage position or the storage position. Alternatively, the image-capturing device 1 may be detected to be in the operating state or the non-operating state depending upon whether or not the illuminating light 4 is lit. In the latter case, the image-capturing device 1 is determined to be in the operating state when the illuminating lamp 4 has been turned on by the user. The image-capturing device 1 is determined to be in the non-operating state when the illuminating lamp 4 has been turned off by the user. When the operating/non-operating state of the image-capturing device 1 is determined, the following operations can be performed.

1. If the image-capturing device 1 is detected to be in the operating state, the image signal from the image-capturing device 1 is selected.

2. If the image-capturing device is detected to be in the non-operating state, the output of an image signal by the image-capturing device 1 is prohibited.

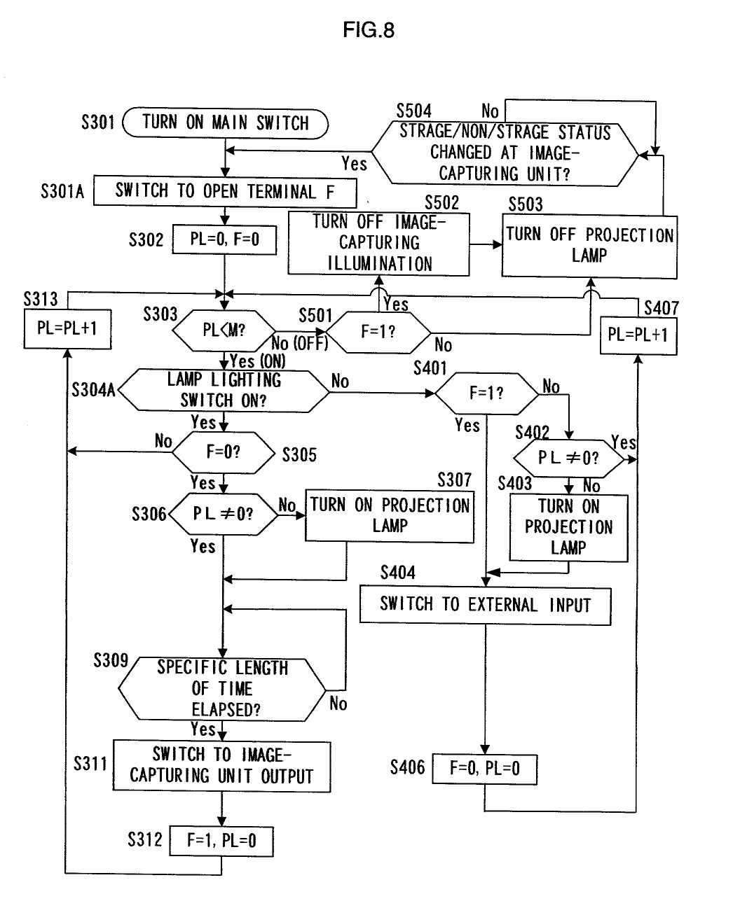

FIG. 8 is a flowchart of the processing procedure through which image input selection and the like are implemented by determining the operating/non-operating state of the image-capturing device based upon the ON/OFF state of the illuminating lamp. The procedure shown in FIG. 8 differs from the processing shown in FIG. 5 in that;

i) step S304 is replaced with step S304A

ii) the processing in steps S308 and S405 is not performed. It is to be noted that the same step numbers are assigned to steps in which processing identical to that shown in FIG. 5 is performed to preclude the necessity for a repeated explanation.

In step S304A shown in FIG. 8, a decision is made as to whether or not the switch at the operating panel 10 for turning on the illuminating lamp 4 is in an ON state. The control unit 53 (53A) makes an affirmative decision in step S304A if the lighting switch is turned on to proceed to step S305, whereas it makes a negative decision in step S304A if the lighting switch is in an OFF state to proceed to step S401. In step S311, to which the operation proceeds following the processing in step S305, a switching operation is performed to select an image-capturing signal resulting from an image-capturing operation at the image-capturing device. In step S404, to which the operation proceeds following the processing in step S401, a switching operation is performed to select an external input signal.

As explained above, the image input/output apparatus according to the present invention implements ON/OFF control of the illuminating lamp 4 and ON/OFF control of the projection lamp 31 and switches the image signal input depending upon whether the arm supporting the image-capturing device 1 is in the non-stored state or the stored state. In addition, the document presentation apparatus according to the present invention switches the image signal input depending upon the ON/OFF state of the illuminating lamp 4. The present invention is not limited to the embodiments explained earlier and it may be adopted in various processing procedures in conjunction with various circuits and various structures as long as the functions described above are realized.

Second Embodiment of Document Presentation Apparatus

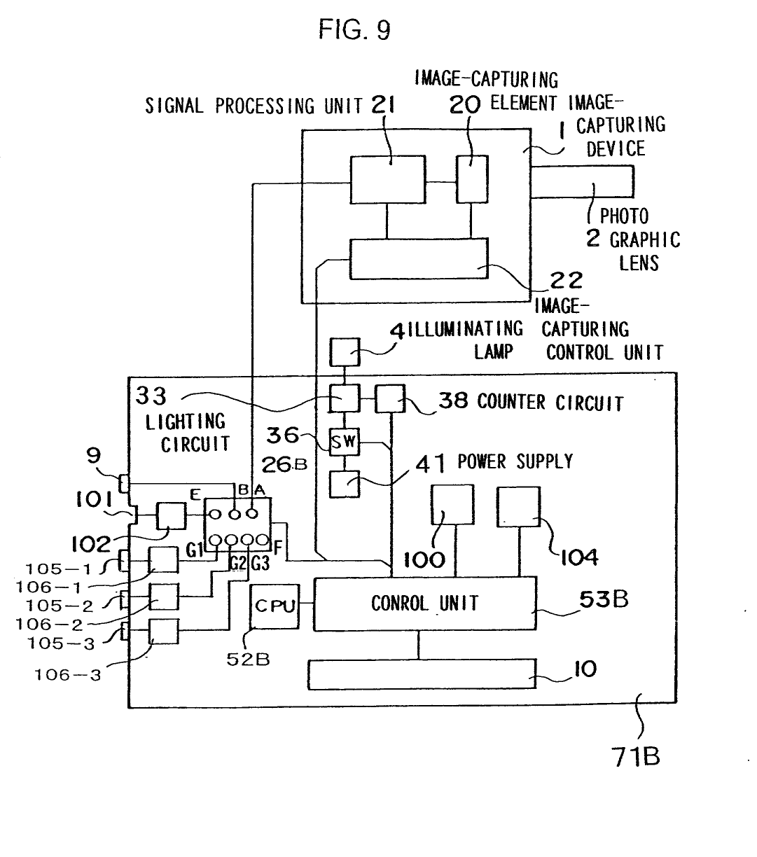

FIG. 9 illustrates the structure assumed in the second embodiment of the document presentation apparatus. The document presentation apparatus shown in FIG. 9 includes the image-capturing device 1 and a stage 71B. The same reference numbers are assigned to components identical to those shown in FIG. 7 to preclude the necessity for a repeated explanation. The stage 71B is provided with a selector switch circuit 26B. The selector switch circuit 26B is provided with three input terminals A, B and E, one open terminal F and three output terminals G1, G2 and G3. An image signal provided by the image-capturing device 1 is input to the input terminal A. An external image signal input through an external analog RGB input terminal 9 is input to the input terminal B. An image signal from a PC card installed at the slot 101 is input to the input terminal E. The open terminal F is an open terminal to which no image signal is input.

The output terminal G1 is connected to an external analog RGB output terminal 105-1 via an analog output signal processing circuit 106-1. The output terminal G2 is connected to a PC card installed at a PC card slot 105-2 via a PC card output signal processing circuit 1062. The output terminal G3 is connected to an external digital image output terminal 105-3 via a digital image signal processing circuit 106-3. The digital image output as referred to in this context is an output to a DVI, USB or Ethernet.

The selector switch circuit 26B allows the three individual output terminals G1, G2 and G3 to be connected with one of the three input terminals A, B and E or the open terminal F independently of one another. For instance, the image signal provided by the image-capturing device 1, which is input to the input terminal A, may be output to the output terminals G1 and G2 while outputting the image signal from the PC card which is input to the input terminal E to the output terminal G3. In such a case, the image signal provided by the image-capturing device 1 is output through the output terminals G1 and G2 as an analog RGB signal and a PC card signal respectively. The image signal from the PC card installed at the PC card slot 101 is output through the output terminal G3 as a digital image signal.

The selector switch circuit 26B is capable of detecting whether or not an image signal has been input to each input terminal or whether or not the PC card is connected and transmitting the detection signal to a CPU 52B via a control unit 53B. Switching control is implemented on the selector switch circuit 26B by the CPU 52B via the control unit 53B.

The document presentation apparatus in the second embodiment is characterized in that images are switched by the selector switch circuit 26A in correspondence to the image signal input status. The following operations can be achieved when an input to a given input terminals of the selector switch circuit 26B has been detected or a connection of a PC card has been detected.

1. If an image signal input to the input terminal A is detected, the input terminal A of the selector switch circuit 26B is connected to the output terminals G1, G2 and G3 of the selector switch circuit 26B.

2. If an image signal input to the input terminal B is detected, the input terminal B of the selector switch circuit 26B is connected to the output terminals G1, G2 and G3 of the selector switch circuit 26B.

3. If a PC card connected to the input terminal E is detected, the input terminal E of the selector switch circuit 26B is connected to the output terminals G1, G2 and G3 of the selector switch circuit 26B.

4. If no image signal input or PC card connection is detected at the input terminal A, B or E, the open terminal F of the selector switch circuit 26B is connected to the output terminals G1, G2 and G3 of the selector switch circuit 26B.

The CPU 52B detects via the control unit 53B whether or not an image signal has been input from the image-capturing device 1 to the input terminal A of the selector switch circuit 26B. The detection as to whether or not an image signal has been input may be achieved by, for instance, detecting the signal level of the image signal or the frequency of the synchronous signal contained in the image signal. Upon detecting that an image signal from the image-capturing device 1 has been input, the CPU 52B outputs a command to the control unit 53B to connect the output terminals G1, G2 and G3 of the selector switch circuit 26B to the input terminal A.

The CPU 52B detects via the control unit 53B whether or not an image signal from the external analog RGB terminal 9 has been input to the input terminal B of the selector switch circuit 26B. The detection as to whether or not an image signal has been input may be performed by detecting the signal level or the frequency of the synchronous signal contained in the image signal as in the detection of the signal from the image-capturing device 1. Upon detecting an image signal input from the analog RGB terminal 9, the CPU 52B outputs a command to the control unit 53 B to connect the output terminals G1, G2 and G3 of the selector switch circuit 26B to the input terminal B.

The CPU 52B detects via the control unit 53B whether or not the PC card installed at the slot 101 is connected to the input terminal E of the selector switch circuit 26B. The detection as to whether or not the PC card is connected may be performed by detecting the level of the voltage at a specific terminal of the connector (not shown) inside the slot 101. The voltage level at the specific terminal is input to the CPU 52B via the decode circuit 102, the selector switch circuit 26B and the control unit 53B. Upon detecting that the PC card is installed in the slot 101, the CPU 52B outputs a command to the control unit 53B to connect the output terminals G1, G2 and G3 of the selector switch circuit 26B to the input terminal E.

If no image signal input or PC card connection is detected at the input terminal A, B or E of the selector switch circuit 26B, the CPU 52B outputs a command to the control unit 53B to connect the output terminals G1, G2 and G3 of the selector switch circuit 26B to the open terminal F.

It is to be noted that if image signal are simultaneously input to both the input terminal A and the input terminal B and also a PC card is installed in the slot 101 at the same time, the output terminals G1, G2 and G3 should be connected to the input terminal determined to be given first priority in advance.

While the CPU 52B described above switches connections of all the output terminals G1, G2 and G3, depending upon whether or not an image signal has been input to a given input terminal or whether not a connection to a specific input terminal has been achieved by loading a PC card at the slot 101, it may instead switch the connection of a specific output terminal or terminals independently.

As explained above, the document presentation apparatus in the second embodiment switches the image signal input depending upon whether or not an image signal has been input to the input terminal A or B at the stage 71B or depending upon whether or not a PC card is connected to the input terminal E. The present invention may also be adopted in an image input/output apparatus by providing the image selector switch circuit 26B at a projection-type display device.

The detection as to whether or not an image signal has been input to an input terminal may be performed based upon whether or not a cable is connected to the input terminal, as well.

The explanation given above mainly focuses on the processing of image signal. Under normal circumstances, image signals are often used in conjunction with audio signals. Audio signals may be processed together with image signal by providing a reproduction circuit for reproducing the audio signals and an audio selector switch and switching the input at the audio selector switch in synchronization with the input selection at the image selector switch 26. In that case, the audio signal selected through the audio selector switch is reproduced at the reproduction circuit in synchronization with the image selection.

What is claimed is;

1. An image input/output apparatus comprising;
an image-capturing device that assumes the operating state or the non-operating state and captures an image of a subject placed on a stage;
an image generating means for generating an image based upon an image signal input thereto;
a projection illuminating device that illuminates and projects the image generated by said image generating means;
a detection means for detecting whether or not said image-capturing device is in the operating state;
a selection means for selecting and outputting to said image generating means either a first image signal output by said image-capturing device or a second image signal input from the outside; and
a control means for driving said selector so as to select the first image signal if said detection means detects that said image-capturing device is in the operating state.

2. An image input/output apparatus according to claim 1, wherein;
said detection means detects a shift from the non-operating state to the operating state occurring in said image-capturing device.

3. An image input/output apparatus according to claim 1, further comprising;
a power switch through which a power-up command is issued, wherein;
said control means engages said detection means to detect whether or not said image-capturing device is in the operating state when power is turned on through said power switch.

4. An image input/output apparatus comprising;
an image-capturing device that assumes the operating state or the non-operating state and captures an image of a subject placed on a stage;
an image generating means for generating an image based upon an image signal input thereto;
a projection illuminating device that illuminates and projects the image generated by said image generating means;
a detection means for detecting whether or not said image-capturing device is in the operating state; and
a control means for turning on said projection illuminating device if said detection means detects that said image-capturing device is in the operating state.

5. An image input/output apparatus comprising;
an image-capturing device that assumes an operating state or the non-operating state and captures an image of a subject placed on a stage;
a subject illuminating device that illuminates the subject placed on said stage;
an image generating means for generating an image based upon an image signal input thereto;
a projection illuminating device that illuminates and projects the image generated by said image generating means;
a detection means for detecting whether or not said image-capturing device is in the operating state;
a determination means for determining that said subject illuminating device is fully lit; and
a control means for turning on said subject illuminating device if said detection means detects that said image-capturing device is in the operating state and prohibiting output of the image signal until said determination means determines that said subject illuminating device is fully lit.

6. An image input/output apparatus comprising;
an image-capturing device that assumes the operating state or the non-operating state and captures an image of a subject placed on a stage;
a subject illuminating device that illuminates the subject placed on said stage;
an image generating means for generating an image based upon an image signal input thereto;
a projection illuminating device that illuminates and projects the image generated by said image generating means;
a selection means for selecting and outputting to said image generating means either a first image signal output by said image-capturing device or a second image signal input from the outside;
a detection means for detecting whether or not said image-capturing device is in the operating state; and
a determination means for determining that said subject illuminating device is fully lit; and
a control means for turning on said subject illuminating device if said detection means detects that said image-capturing device is in the operating state and driving said selection means so as to select the first image signal after said determination means determines that said subject illuminating device is fully lit.

7. An document presentation apparatus comprising;
an image-capturing device that assumes the operating state or the non-operating state and captures an image of a subject placed on a stage;
a detection means for detecting whether or not said image-capturing device is in the operating state;
a selection means for selecting and outputting either a first image signal output by said image-capturing device or a second image signal input from the outside; and
a control means for driving said selection means so as to select the first image signal if said detection means detects that said image-capturing device is in the operating state.

8. A document presentation apparatus comprising;
an image-capturing device that assumes the operating state or the non-operating state and captures an image of a subject placed on a stage;
a subject illuminating device that illuminates the subject placed on said stage;
a detection means for detecting whether or not said image-capturing device is in the operating state;
a determination means for determining that said subject illuminating device is fully lit; and
a control means for turning on said subject illuminating device if said detection means detects that said image-capturing device is in the operating state and prohibiting output of the image signal until said determination means determines that said subject illuminating device is fully lit.

9. A document presentation apparatus comprising;
an image-capturing device that assumes the operating state or the non-operating state and captures an image of a subject placed on a stage;
a subject illuminating device that illuminates the subject placed on said stage;
a selection means for selecting and outputting either a first image signal output by said image-capturing device or a second image signal input from the outside;
a detection means for detecting whether or not said image-capturing device is in the operating state;
a determination means for determining that said subject illuminating device is fully lit; and
a control means for turning on said subject illuminating device if said detection means detects that said image-capturing device is in the operating state and driving said selection means so as to select the first image signal after said determination means determines that said subject illuminating device is fully lit.

10. A document presentation apparatus comprising;
an image-capturing device that assumes the operating state or the non-operating state, captures an image of a subject placed on a stage and outputs an image signal;
a detection means for detecting whether or not said image-capturing device is in the non-operating state; and
a prohibiting means for prohibiting output of the image signal if said detection means detects that said image-capturing device is in the non-operating state.

11. An image input/output apparatus comprising;
an image-capturing device that assumes the operating state or the non-operating state and captures an image of a subject placed on a stage;
an image generating means for generating an image based upon an image signal input thereto;
a projection illuminating device that illuminates and projects the image generated by said image generating means;
a detection means for detecting whether or not said image-capturing device is in the non-operating state;
a selection means for selecting and outputting to said image generating means either a first image signal output by said image-capturing device or a second image signal input from the outside; and
a control means for driving said selection means so as to select the second image signal if said detection means detects that said image-capturing device is in the non-operating state.

12. An image input/output apparatus according to claim 11, further comprising;
a subject illuminating device that illuminates the subject placed on said stage, wherein;
said control means turns off said subject illuminating device after selecting the second image signal by driving said selection means if said detection means detects that said image-capturing device is in the non-operating state.

13. A document presentation apparatus comprising;
an image-capturing device that assumes the operating state or the non-operating state and captures an image of a subject placed on a stage;
a selection means for selecting and outputting either a first image signal output by said image-capturing device or a second image signal input from the outside;
a detection means for detecting whether or not said image-capturing device is in the non-operating state; and
a control means for driving said selection means so as to output the second image signal if said detection means detects that said image-capturing device is in the non-operating state.

14. A document presentation apparatus according to claim 13, further comprising;
a subject illuminating device that illuminates the subject placed on said stage, wherein;
said control means turns off said subject illuminating device after selecting the second image signal by driving said selection means if a said detection means detects that said image-capturing device is in the non-operating state.

15. An image input/output apparatus, comprising;
an image-capturing device that captures an image of a subject placed on a stage;
a subject illuminating device that illuminates the subject;
an image generating means for generating an image based upon an image signal input thereto;
a projection illuminating device that illuminates and projects the image generated by said image generating means;
a selection means for selecting and outputting to said image generating means either a first image signal input from said image-capturing device or a second image signal input from the outside;
a detection means for detecting an ON/OFF state of said subject illuminating device; and
a control means for driving said selection means so as to output the first image signal if said detection means detects the ON state and to output the second image signal if said detection means detects the OFF state.

16. A document presentation apparatus, comprising;
an image-capturing device that captures an image of a subject placed on a stage;
a subject illuminating device that illuminates the subject;
a selection means for selecting and outputting either a first image signal input from said image-capturing device or a second image signal input from the outside;
a detection means for detecting an ON/OFF state of said subject illuminating device; and
a control means for driving said selection means so as to output the first image signal if said detection means detects the ON state and to output the second image signal if said detection means detects the OFF state.

17. An image input/output apparatus, comprising;
an image-capturing device that captures an image of a subject placed on a stage;
an image generating means for generating an image based upon an image signal input thereto;
a projection illuminating device that illuminates and projects the image generated by said image generating means;
a selection means for selecting and outputting to said image generating means either a first image signal input from said image-capturing device or a second image signal input from the outside;
a detection means for detecting whether or not the first image signal or the second image signal has been input; and
a control means for driving said selection means so as to output the image signal, the input of which has been detected by said detection means.

18. An image input/output apparatus according to claim 17, wherein;
said control means prohibits an image signal output by said selection means if said detection means does not detect either the first image signal or the second image signal.

19. A document presentation apparatus, comprising;
an image-capturing device that captures an image of a subject placed on a stage;
a selection means for selecting and outputting either a first image signal input from said image-capturing device or a second image signal input from the outside;
a detection means for detecting whether or not the first image signal or the second image signal has been input; and
a control means for driving said selection means so as to output the image signal, the input of which has been detected by said detection means.

20. A document presentation apparatus according to claim 19, wherein;
said control means prohibits an image signal output by said selection means if said detection means does not detect either the first image signal or the second image signal.
